(19) United States
(12) Patent Application Publication
(10) Pub. No.: US 2025/0046513 A1
(43) Pub. Date: Feb. 6, 2025

(54) COIL COMPONENT

(71) Applicant: Murata Manufacturing Co., Ltd., Kyoto-fu (JP)

(72) Inventors: Akio IGARASHI, Nagaokakyo-shi (JP); Shogo NISHIKAWA, Nagaokakyo-shi (JP)

(73) Assignee: Murata Manufacturing Co., Ltd., Kyoto-fu (JP)

(21) Appl. No.: 18/789,286

(22) Filed: Jul. 30, 2024

(30) Foreign Application Priority Data
Aug. 1, 2023 (JP) 2023-125333

(51) Int. Cl. H01F 27/32; H01F 27/24; H01F 27/28; H01F 27/30

(52) U.S. Cl. CPC H01F 27/325; H01F 27/24; H01F 27/2823; H01F 27/306

(57) ABSTRACT

In a winding portion of a first wire and a winding portion of a second wire wound around a winding core portion in a state of being adjacent to each other, insulating coatings include large-diameter portions and small-diameter portions having an outer diameter smaller than an outer diameter of the large-diameter portions. The large-diameter portions and the small-diameter portions are distributed over a plurality of parts in a direction in which the wires extend. Spaces are formed between the first winding portion and the second winding portion due to a difference in size in a radial direction between the large-diameter portions and the small-diameter portions and contribute to a reduction of electrostatic capacity.

### CROSS-REFERENCE TO RELATED APPLICATION

This application claims benefit of priority to Japanese Patent Application No. 2023-125333, filed Aug. 1, 2023, the entire content of which is incorporated herein by reference.

### BACKGROUND

### Technical Field

The present disclosure relates to a coil component having a structure in which at least two wires are wound around a winding core portion included in a bobbin and, in particular, relates to the forms of insulating coatings included in the wires.

### Background Art

Examples of a coil component interested in the present disclosure include a coil component forming a common mode choke coil or a transformer. The coil component forming a common mode choke coil or a transformer includes a bobbin and at least two wires. The bobbin includes a winding core portion around which the wires are wound. The at least two wires include a first wire and a second wire each wound around the winding core portion.

Typically, the first wire and the second wire respectively include a first winding portion and a second winding portion that are wound around the winding core portion and that are formed other than respective end portions of the first wire and the second wire connected to terminal electrodes.

As illustrated in FIG. 9, a first wire 1 and a second wire 2 respectively include central conductors 3 and 4 and insulating coatings 5 and 6. The central conductors 3 and 4 are made of a highly conductive metal. The insulating coatings 5 and 6 cover peripheral surfaces of the central conductors 3 and 4 and are made of an electrically insulating resin. Sections of a first winding portion and a second winding portion such as the ones described above of the first wire 1 and the second wire 2 each have a circular shape.

The first winding portion and the second winding portion of the first wire 1 and the second wire 2 are wound around a winding core portion in a state of being adjacent to each other as illustrated in FIG. 9. In this state, when there is a potential difference between the first wire 1 and the second wire 2, an electrostatic capacity is generated between the first wire 1 and the second wire 2. A large electrostatic capacity adversely affects the electrical characteristics of a common mode choke coil or a transformer.

Thus, it is desirable to reduce such an electrostatic capacity. For example, Japanese Unexamined Patent Application Publication (Translation of PCT Application) No. 2017-537462 describes a structure in which a wall made of an electrically insulating material and having a tube section shape is disposed between a first wire wound on the inner layer side and a second wire wound on the outer layer side to reduce electrostatic capacity.

### SUMMARY

In the structure described in Japanese Unexamined Patent Application Publication (Translation of PCT Application) No. 2017-537462, the wall having a tube section shape prevents a coil component from being reduced in size. In addition, such a wall having a tube section shape is required to be prepared as an additional component. Thus, the structure described in Japanese Unexamined Patent Application Publication (Translation of PCT Application) No. 2017-537462 has a problem of complicating the manufacturing process of the coil component and increasing costs.

Accordingly, the present disclosure provides a coil component capable of inhibiting generation of stray capacitance without an additional component such as a wall having a tube section shape.

The present disclosure relates to a coil component including a bobbin including a winding core portion; and at least two wires wound around the winding core portion and including a first wire and a second wire each including a central conductor and an insulating coating. The insulating coating covers a peripheral surface of the central conductor and being made of an electrically insulating resin.

In the coil component according to the present disclosure, the first wire and the second wire respectively include a first winding portion and a second winding portion that are wound around the winding core portion in a state of being adjacent to each other. In at least one of the first winding portion and the second winding portion, the insulating coating includes large-diameter portions and small-diameter portions having an outer diameter smaller than an outer diameter of the large-diameter portions, the large-diameter portions and the small-diameter portions being distributed over a plurality of parts in a direction in which the wires extend.

According to the present disclosure, the large-diameter portions and the small-diameter portions coexist in the insulating coatings of the wires, and spaces are thus formed between the first winding portion and the second winding portion due to a difference in size in a radial direction between the large-diameter portions and the small-diameter portions. The spaces can be filled with air having a low permittivity, thus contributing to a reduction of the electrostatic capacity generated between the first winding portion and the second winding portion.

### BRIEF DESCRIPTION OF THE DRAWINGS

FIG. 1 is a sectional view illustrating the schematic configuration of a coil component according to Embodiment 1 of the present disclosure;

FIG. 2 is a sectional view that is taken along line A-A in FIG. 1 and that schematically illustrates a first winding portion of a first wire and a second winding portion of a second wire of the coil component illustrated in FIG. 1, the first winding portion and the second winding portion being wound around a winding core portion in a state of being adjacent to each other;

FIG. 3 is a sectional view, taken along line B-B in FIG. 2, of the first winding portion of the first wire and the second winding portion of the second wire;

FIG. 4 is a sectional view, for describing Embodiment 2 of the present disclosure, that corresponds to FIG. 2 and that schematically illustrates the first winding portion of the first wire and the second winding portion of the second wire wound around the winding core portion in the state of being adjacent to each other;

FIG. 5 is a sectional view, taken along line C-C in FIG. 4, of the first winding portion of the first wire and the second winding portion of the second wire;

FIG. 6 is a sectional view, for describing Embodiment 3 of the present disclosure, that corresponds to FIG. 2 and that illustrates the winding portion of the wire;

FIG. 7 is a sectional view, for describing Embodiment 4 of the present disclosure, that corresponds to FIG. 2 and that illustrates the winding portion of the wire;

FIG. 8 is a sectional view, for describing Embodiment 5 of the present disclosure, that corresponds to FIG. 2 and that illustrates the winding portion of the wire; and

FIG. 9 is a sectional view, for describing the related art of the present disclosure, of the first winding portion of the first wire and the second winding portion of the second wire.

### DETAILED DESCRIPTION

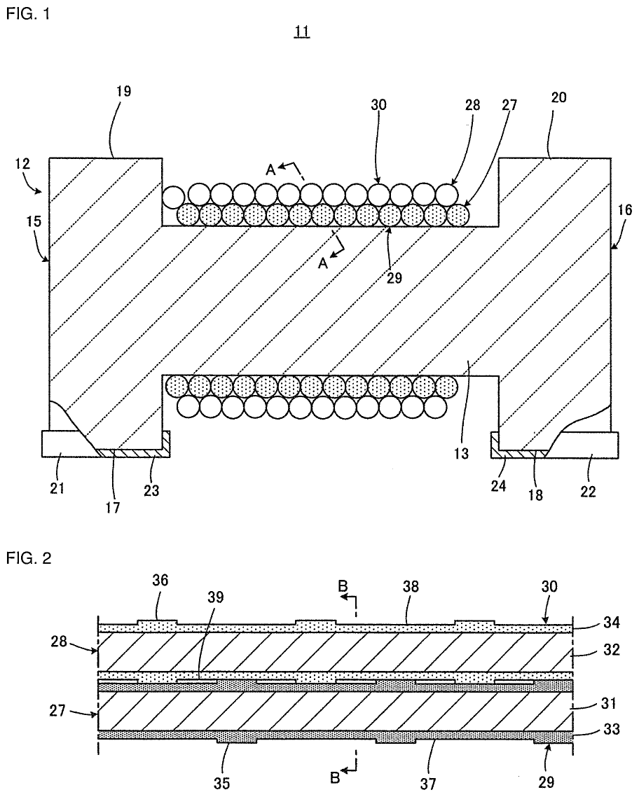

The schematic configuration of a coil component 11 according to Embodiment 1 of the present disclosure will be described with reference to FIG. 1.

The coil component 11 forms, for example, a common mode choke coil. The coil component 11 includes a bobbin 12. The bobbin 12 includes a winding core portion 13, and a first flange portion 15 and a second flange portion 16, which are provided at opposite end portions of the winding core portion 13 in the axial direction. The bobbin 12 is preferably made of ferrite. The bobbin 12 may be made of a nonconductive material other than ferrite such as a nonmagnetic material such as alumina, a resin such as a plastic, or a resin containing ferrite powder or metal magnetic powder.

The winding core portion 13 and the first flange portion 15 and the second flange portion 16 included in the bobbin 12 have, for example, a quadrangular prism shape having a quadrilateral sectional shape. In addition, edge portions of each of the winding core portion 13 and the flange portions 15 and 16 having a quadrangular prism shape may be roundly chamfered. In addition to a quadrilateral shape, sectional shapes of the winding core portion 13 and the flange portions 15 and 16 may be a polygonal shape such as a hexagon, a circular shape, an elliptical shape, or a combination of these shapes.

The first flange portion 15 has a bottom surface 17, which faces a mounting substrate side when being mounted, and a top surface 19, which faces in the direction opposite to the direction in which the bottom surface 17 faces. Similarly to the first flange portion 15, the second flange portion 16 has a bottom surface 18, which faces a mounting substrate side when being mounted, and a top surface 20, which faces in the direction opposite to the direction in which the bottom surface 18 faces.

Although not illustrated in detail, a first terminal electrode 21 and a third terminal electrode 23 are provided at the bottom surface 17 of the first flange portion 15 in a state of being arranged in a direction orthogonal to FIG. 1 and being spaced from each other. A second terminal electrode 22 and a fourth terminal electrode 24 are provided at the bottom surface 18 of the second flange portion 16 in a state of being arranged in the direction orthogonal to FIG. 1 and being spaced from each other. In FIG. 1, the first terminal electrode 21 and the second terminal electrode 22 are illustrated in a state of being formed on respective outer surfaces of the first flange portion 15 and the second flange portion 16, and the third terminal electrode 23 and the fourth terminal electrode 24 are illustrated with sections together with respective parts of the first flange portion 15 and the second flange portion 16.

The coil component 11 further includes at least two wires each wound around the winding core portion 13. In the present embodiment, the wires include a first wire 27 and a second wire 28. To clarify the distinction between the first wire 27 and the second wire 28 in FIG. 1, the first wire 27 is shaded in FIG. 1. The first wire 27 and the second wire 28 respectively include a first winding portion 29 and a second winding portion 30, which are wound around the winding core portion 13. The first wire 27 is wound so as to form an inner layer with the first winding portion 29. The second wire 28 is wound so as to form an outer layer with the second winding portion 30. Although not illustrated, respective end portions of the first wire 27 are connected to the first terminal electrode 21 and the second terminal electrode 22, and respective end portions of the second wire 28 are connected to the third terminal electrode 23 and the fourth terminal electrode 24. For example, thermocompression bonding is applied to these connections.

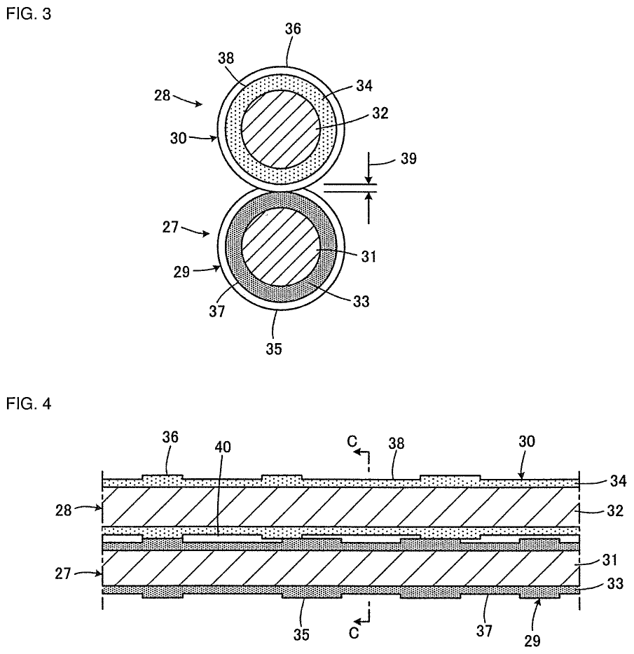

FIG. 2 is an enlarged schematic sectional view, taken along line A-A in FIG. 1, of the first winding portion 29 of the first wire 27 and the second winding portion 30 of the second wire 28, the first winding portion 29 and the second winding portion 30 being wound around the winding core portion 13 illustrated in FIG. 1. As illustrated in FIG. 2, the first winding portion 29 of the first wire 27 and the second winding portion 30 of the second wire 28 are in a state of being adjacent to each other. FIG. 3 is a sectional view, enlarged more than FIG. 2 and taken along line B-B in FIG. 2, of the first winding portion 29 of the first wire 27 and the second winding portion 30 of the second wire 28.

In FIGS. 2 and 3, the first wire 27 and the second wire 28 respectively include central conductors 31 and 32 and insulating coatings 33 and 34. The central conductors 31 and 32 are made of a highly conductive metal such as copper, silver, or gold. The insulating coatings 33 and 34 cover peripheral surfaces of the central conductors 31 and 32 and are made of an electrically insulating resin such as polyurethane, polyamideimide, or polyester. In the first winding portion 29 and the second winding portion 30 described above, sections of parts of the central conductors 31 and 32 each have a circular shape and have a diameter substantially uniform in the direction in which the wires 27 and 28 extend.

On the other hand, the size of the insulating coatings 33 and 34 in a radial direction varies in the direction in which the wires 27 and 28 extend. That is, a part of the insulating coating 33 of the first winding portion 29 on the first wire 27 side includes large-diameter portions 35 and small-diameter portions 37 having an outer diameter smaller than that of the large-diameter portions 35. A part of the insulating coating 34 of the second winding portion 30 on the second wire 28 side includes large-diameter portions 36 and small-diameter portions 38 having an outer diameter smaller than that of the large-diameter portions 35.

The large-diameter portions 35 and the small-diameter portions 37 of the part of the insulating coating 33 of the first winding portion 29 are distributed over a plurality of parts in the direction in which the first wire 27 extends. The large-diameter portions 36 and the small-diameter portions 38 of the part of the insulating coating 34 of the second winding portion 30 are distributed over a plurality of parts in the direction in which the second wire 28 extends.

In the present embodiment, the large-diameter portions 35 and the small-diameter portions 37 on the first winding portion 29 side are alternately disposed at regular intervals in the direction in which the first wire 27 extends. Similarly, the large-diameter portions 36 and the small-diameter portions 38 on the second winding portion 30 side are alternately disposed at regular intervals in the direction in which the second wire 28 extends.

In addition, the large-diameter portions 35 and the large-diameter portions 36 are equal in length measured in the direction in which the first wire 27 and the second wire 28 extend, and the small-diameter portions 37 and the small-diameter portions 38 are equal in length measured in the direction in which the first wire 27 and the second wire 28 extend.

In addition, the intervals at which the large-diameter portions 35 and the small-diameter portions 37 on the first winding portion 29 side are disposed are equal to the intervals at which the large-diameter portions 36 and the small-diameter portions 38 on the second winding portion 30 side are disposed. In addition, the large-diameter portions 33 on the first winding portion 29 side face the small-diameter portions 38 on the second winding portion 30 side, and the small-diameter portions 37 on the first winding portion 29 side face the large-diameter portions 36 on the second winding portion 30 side.

In addition, in the first winding portion 29 and the second winding portion 30, the thickness of the insulating coatings 33 and 34 at the positions of the large-diameter portions 35 and 36 is preferably 2 times or less the thickness of the insulating coatings 33 and 34 at the positions of the small-diameter portions 37 and 38. In addition, the thickness of the insulating coatings 33 and 34 at the positions of the large-diameter portions 35 and 36 is preferably 1.1 times or more the thickness of the insulating coatings 33 and 34 at the positions of the small-diameter portions 37 and 38.

In addition, in the present embodiment, the thickness of the insulating coating 33 at the positions of the large-diameter portions 35 in the first winding portion 29 is substantially equal to the thickness of the insulating coating 34 at the positions of the large-diameter portions 36 in the second winding portion 30, and the thickness of the insulating coating 33 at the positions of the small-diameter portions 37 in the first winding portion 29 is substantially equal to the thickness of the insulating coating 34 at the positions of the small-diameter portions 38 in the second winding portion 30.

As described above, according to the present embodiment, the large-diameter portions 35 and 36 and the small-diameter portions 37 and 38 respectively coexist in the insulating coatings 33 and 34. Accordingly, spaces 39 are formed between the first winding portion 29 and the second winding portion 30 due to the difference in size in the radial direction between the large-diameter portions 35 and 36 and the small-diameter portions 37 and 38. The spaces 39 are typically filled with air having a low permittivity, thus contributing to a reduction of the electrostatic capacity generated between the first winding portion 29 and the second winding portion 30. In the present embodiment, the spaces 39 have a size corresponding to the difference in size in the radial direction between the large-diameter portions 35 and 36 and the small-diameter portions 37 and 38.

When a sectional shape of the winding core portion is a polygonal shape such as a quadrilateral, preferably, at least one large-diameter portion is formed on one side of the polygonal shape, or the large-diameter portion is formed on at least one corner of the polygonal shape. When a sectional shape of the winding core portion is a circular shape or an elliptical shape, at least one large-diameter portion is preferably located on the circumference of the shape.

In addition, in the present embodiment, there are two variations in thickness, that is, the thickness of the large-diameter portions 35 and 36 and the thickness of the small-diameter portions 3 and 38, but there may be three or more variations in thickness.

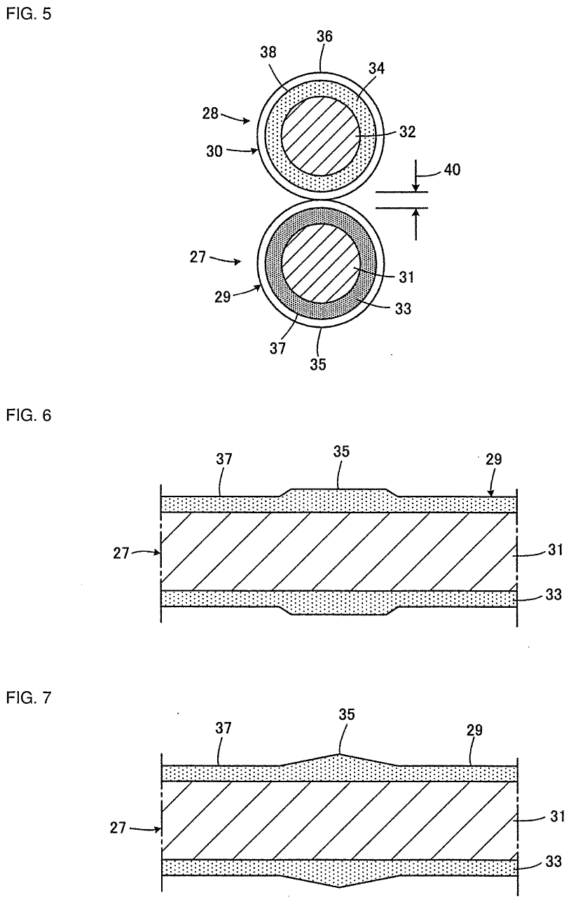

Next, Embodiment 2 of the present disclosure will be described with reference to FIGS. 4 and 5. FIG. 4 is a sectional view corresponding to FIG. 2. FIG. 5 is a diagram corresponding to FIG. 3. In FIGS. 4 and 5, components corresponding to components illustrated in FIGS. 2 and 3 have the same reference signs, and redundant descriptions thereof are omitted.

In the present embodiment, the large-diameter portions 35 and the small-diameter portions 37 on the first winding portion 29 side are alternately disposed at irregular intervals in the direction in which the first wire 27 extends. Similarly, the large-diameter portions 36 and the small-diameter portions 38 on the second winding portion 30 side are alternately disposed at irregular intervals in the direction in which the second wire 28 extends.

Thus, there is no particular regularity of arrangement between the large-diameter portions 35 and the small-diameter portions 37 on the first winding portion 29 side and the large-diameter portions 36 and the small-diameter portions 38 on the second winding portion 30 side.

As a result, some of the large-diameter portions 35 on the first winding portion 29 side face the large-diameter portions 36 on the second winding portion 30 side, and others of the large-diameter portions 35 on the first winding portion 29 side face the small-diameter portions 38 on the second winding portion 30 side. Similarly, some of the small-diameter portions 37 on the first winding portion 29 side face the large-diameter portions 36 on the second winding portion 30 side, and others of the small-diameter portions 37 on the first winding portion 29 side face the small-diameter portions 38 on the second winding portion 30 side.

As described above, also according to the present embodiment, the large-diameter portions 35 and 36 and the small-diameter portions 37 and 38 respectively coexist in the insulating coatings 33 and 34. Accordingly, spaces 40 are formed between the first winding portion 29 and the second winding portion 30 due to the difference in size in the radial direction between the large-diameter portions 35 and 36 and the small-diameter portions 37 and 38. In the present embodiment, the largest parts of the spaces 40 have a size corresponding to 2 times the difference in size in the radial direction between the large-diameter portions 35 and 36 and the small-diameter portions 37 and 38.

In Embodiments 1 and 2 described above, the first winding portion 29 and the second winding portion 30 wound around the winding core portion 13 in a state of being adjacent to each other respectively include the large-diameter portions 35 and 36 and the small-diameter portions 37 and 38. However, only one of the first winding portion and the second winding portion may include the large-diameter portions and the small-diameter portions. Also in this case, spaces can be formed between the first winding portion and the second winding portion due to the difference in size in the radial direction between the large-diameter portions and the small-diameter portions.

In addition, in Embodiments 1 and 2, the large-diameter portions 35 and 36 have a stepped shape rising from the small-diameter portions 37 and 38 in a direction orthogonal to the direction in which the wires 27 and 28 extend, that is, a quadrilateral sectional shape. However, it is possible to freely change this shape.

FIGS. 6 to 8 are diagrams, for describing other embodiments of the present disclosure, illustrating modification examples of the large-diameter portion. FIGS. 6 to 8 each illustrate only one of the first winding portion of the first wire and the second winding portion of the second wire wound around the winding core portion in a state of being adjacent to each other, for example, only the first winding portion 29 of the first wire 27. Thus, in FIGS. 6 to 8, reference signs related to the first winding portion 29 of the first wire 27 are the same as those used in FIG. 2, and redundant descriptions thereof are omitted. Although not illustrated, the other wire winding portion may include or does not have to include the large-diameter portions and the small-diameter portions.

The large-diameter portion 35 having a trapezoid sectional shape is provided in Embodiment 3 illustrated in FIG. 6.

The large-diameter portion 35 having a triangle sectional shape is provided in Embodiment 4 illustrated in FIG. 7.

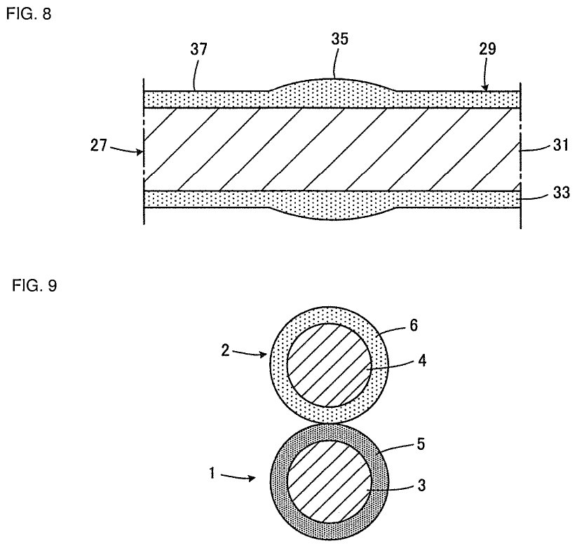

The large-diameter portion 35 having a semi-elliptical sectional shape is provided in Embodiment 5 illustrated in FIG. 8.

To cause the size of the insulating coatings 33 and 34 in the radial direction to vary in the direction in which the wires 27 and 28 extend as in Embodiments 1 to 5 described above, it is possible to use, for example, a method in which the amount of an insulating coating material applied to the peripheral surfaces of the central conductors 31 and 32 to form the insulating coatings 33 and 34 varies, or a method in which, after forming the insulating coatings 33 and 34 so as to have a uniform thickness, the thickness of the insulating coatings 33 and 34 is partially reduced physically by radiating laser light locally thereto or by using a sharp rotary blade. The method in which the thickness of the insulating coatings 33 and 34 is partially reduced by radiating laser light is preferably performed simultaneously with a process of winding the wires 27 and 28 around the winding core portion 13.

The present disclosure has been described above with reference to the illustrated embodiments, but other various embodiments can be implemented within the scope of the present disclosure.

For example, the insulating coatings 33 and 34 are illustrated so as to be uniform, in the circumferential direction, in size in the radial direction. However, the size of the insulating coatings 33 and 34 in the radial direction may vary in the circumferential direction or in both the circumferential direction and the direction in which the wires extend.

In addition, multilayer winding in which the first wire and the second wire are wound around the winding core portion such that one of the first wire and the second wire forms an inner layer and the other of the first wire and the second wire forms an outer layer is used in the illustrated embodiments. However, bifilar winding in which the first wire and the second wire are adjacent to each other in the axial direction of the winding core portion may be used. In addition, winding having a partial structure in which the positional relationship between the first wire and the second wire is changed such that the first wire and the second wire intersect each other may be used. In addition, twisted winding in which the first wire and the second wire are wound in a state of being twisted together may be used.

In addition, in the present disclosure, the large-diameter portions and the small-diameter portions coexist in the insulating coatings of the wires, and the spaces are thus formed between the first winding portion and the second winding portion due to the difference in size in the radial direction between the large-diameter portions and the small-diameter portions, thus desiring an effect of reducing electrostatic capacity. Accordingly, the spaces are preferably filled with air having a low permittivity. However, for example, even when the coil component is impregnated with a resin to fill the spaces with the resin, it is possible to maintain the effect of reducing electrostatic capacity as long as the relative permittivity of the resin is lower than the relative permittivity of the insulating coatings.

In addition, the above embodiments relate to a coil component forming a common mode choke coil. In addition, the present disclosure may be a coil component forming, for example, a transformer.

In addition, the above embodiments are examples, and configurations of different embodiments can be partially replaced or combined.

Embodiments of the present disclosure are as follows.
<1> A coil component including a bobbin including a winding core portion; and at least two wires wound around the winding core portion and including a first wire and a second wire each including a central conductor and an insulating coating, the insulating coating covering a peripheral surface of the central conductor and being made of an electrically insulating resin. The first wire and the second wire respectively include a first winding portion and a second winding portion that are wound around the winding core portion in a state of being adjacent to each other. Also, in at least one of the first winding portion and the second winding portion, the insulating coating includes large-diameter portions and small-diameter portions having an outer diameter smaller than an outer diameter of the large-diameter portions, the large-diameter portions and the small-diameter portions being distributed over a plurality of parts in a direction in which the wires extend.
<2> The coil component according to <1>, in which the large-diameter portions and the small-diameter portions are alternately disposed at regular intervals in the direction in which the wires extend.
<3> The coil component according to <1>, in which the large-diameter portions and the small-diameter portions are alternately disposed at irregular intervals in the direction in which the wires extend.
<4> The coil component according to any one of <1> to <3>, in which a thickness of the insulating coating at positions of the large-diameter portions is 2 times or less a thickness of the insulating coating at positions of the small-diameter portions.
<5> The coil component according to any one of <1> to <4>, in which in both the first winding portion and the second winding portion, the first wire and the second wire include the large-diameter portions and the small-diameter portions.
<6> The coil component according to <5>, in which some of the large-diameter portions on a side of the first winding portion face the large-diameter portions on a side of the second winding portion.
<7> The coil component according to <5> or <6>, in which some of the large-diameter portions on a side of the first winding portion face the small-diameter portions on a side of the second winding portion.
<8> The coil component according to any one of <1> to <7>, in which the first wire and the second wire are wound around the winding core portion such that one of the first wire and the second wire forms an inner layer and another of the first wire and the second wire forms an outer layer.
<9> The coil component according to any one of <1> to <8>, the coil component forming a common mode choke coil.
<10> The coil component according to any one of <1> to <8>, the coil component forming a transformer.

What is claimed is:

1. A coil component comprising:
a bobbin including a winding core portion; and
at least two wires wound around the winding core portion and including a first wire and a second wire each including a central conductor and an insulating coating, the insulating coating covering a peripheral surface of the central conductor and being made of an electrically insulating resin, wherein
the first wire and the second wire respectively include a first winding portion and a second winding portion that are wound around the winding core portion adjacent to each other, and
in at least one of the first winding portion and the second winding portion, the insulating coating includes large-diameter portions and small-diameter portions having an outer diameter smaller than an outer diameter of the large-diameter portions, the large-diameter portions and the small-diameter portions being across a plurality of portions of the insulating coating along a direction in which the wires extend.

2. The coil component according to claim 1, wherein
the large-diameter portions and the small-diameter portions are alternately at regular intervals along the direction in which the wires extend.

3. The coil component according to claim 1, wherein
the large-diameter portions and the small-diameter portions are alternately at irregular intervals along the direction in which the wires extend.

4. The coil component according to claim 1, wherein
a thickness of the insulating coating at locations of the large-diameter portions is 2 times or less a thickness of the insulating coating at locations of the small-diameter portions.

5. The coil component according to claim 1, wherein
in both the first winding portion and the second winding portion, the first wire and the second wire include the large-diameter portions and the small-diameter portions.

6. The coil component according to claim 5, wherein
some of the large-diameter portions on a side of the first winding portion face the large-diameter portions on a side of the second winding portion.

7. The coil component according to claim 5, wherein
some of the large-diameter portions on a side of the first winding portion face the small-diameter portions on a side of the second winding portion.

8. The coil component according to claim 1, wherein
the first wire and the second wire are wound around the winding core portion such that one of the first wire and the second wire defines an inner layer and another of the first wire and the second wire defines an outer layer.

9. The coil component according to claim 1, wherein
the coil component is a common mode choke coil.

10. The coil component according to claim 1, wherein
the coil component is a transformer.
